(19) United States
(12) Patent Application Publication
(10) Pub. No.: US 2011/0030585 A1
(43) Pub. Date: Feb. 10, 2011

(54) BIOREFINERY PRODUCTS IN STRUCTURAL MATERIALS

(75) Inventors: James Hanley Clark, York (GB); Krzysztof Jakub Milkowski, York (GB); Jenifer Ruth Dodson, Berkshire (GB); Vitaliy Lvovich Budarin, York (GB)

Correspondence Address: CHOATE, HALL & STEWART LLP, TWO INTERNATIONAL PLACE, BOSTON, MA, 02110, US

(73) Assignee: UNIVERSITY OF YORK, Heslington, York, North Yorkshire (GB)

(21) Appl. No.: 12/811,631

(22) PCT Filed: Jan. 2, 2009
(86) PCT No.: PCT/GB2009/000002

§ 371 Date: Oct. 1, 2010

(30) Foreign Application Priority Data
Jan. 5, 2008 (GB) 800193.5

(51) Int. Cl. C09D 1/00

(52) U.S. Cl. 106/286.7

(57) ABSTRACT

There is described a structural material comprising a substrate and a binder characterised in that the binder comprises a bio-silicate and a process for the manufacture thereof.

### FIELD OF THE INVENTION

The invention described hereunder pertains to a novel structural material and to a process for production of such materials whereby the main constituent components including an aggregate (substrate), binder and binder setting agent and some or all of the modifiers can be derived from biomass resources including wastes.

The invention covers both the novel holistic approach to the utilisation of the bio-derived raw materials as well as, where appropriate, novel components included in the process.

### BACKGROUND TO THE INVENTION

Composite boards used in the construction and furniture industries are most commonly made from organic fillers and binders. The resultant matrix is consolidated under conditions of heat and high pressure. Binders employed in these applications are generally petroleum based and thus are non-renewable. Formaldehyde based resins (UF (urea formaldehyde) or PRF (phenol formaldehyde)) are probably the most commonly used resins. However, formaldehyde was recently classified as a carcinogen and, being one of the more common indoor air pollutants, is most likely to be phased out in the advent of growing legislation. This will inevitably impact on the wood-based panels industry where 145,000 tonnes of formaldehyde-based phenolic resins are used annually.

Although alternatives to formaldehyde resins are already entering the market they often carry toxicity/environmental concerns of their own and/or they suffer from performance compromises. In addition, the availability of traditional FSC (Forest Stewardship Council) certified substrate materials such as virgin and reclaimed wood for multi-purpose construction boards, such as chip-board, is rapidly diminishing as competing demands such as biomass for energy generation, grow.

An effective alternative to the existing binders is a metal silicate binder traditionally known as “water glass”. The use of water glass as an aggregate binder is known and applied in the construction industry. A silicate solution is typically obtained by fusing sand with soda at high temperatures followed by dissolution of the fused product with high pressure superheated water. The silicate can also be obtained by dissolution of silicate rich minerals such as perlite or clays. The binder can be set through the evaporation of binder solvent (water) and heating and/or use of chemical agents which would cause the silicate binder to polymerise, typically by lowering the pH of the alkaline binder solution. Although a wide range of existing and potential chemical agents can be used to affect such chemical setting, some such agents are more effective than others and can help to afford better control of the process. For example, in a previously patented invention mixed organic esters are used as hardeners whereby they are slowly hydrolysed by a base in the binder solution, consuming the base and causing the pH to drop. Such and similar systems employing silicate binders can be and have been used to bind organic and inorganic aggregates in construction applications including fibre boards. The resulting composites generally have good mechanical strength, weathering stability and low flammability—characteristics, which are highly desirable in construction applications.

The use of alkali metal silicates (silicates) and their aqueous solutions to bind both organic and organic aggregates is known and silicates have been employed to produce plant fibre based structural boards such as those used in the building and/or furniture industry.

Thus, for example, International Patent application No. WO 85/04130 describes manufacturing methods and structural fibre boards which have good fire and water resistance. The boards comprise a lignin-containing fibre material, a binder containing alkali silicate solution, sulphur and/or an inorganic sulphur compound, and a calcium and/or magnesium compound.

Synthesis of silicate solutions from biogenic sources, such as straws, or, in particular, rice hulls, is known. Thus, for example, International Patent application No. WO 2005/077828 describes a methodology for generation of biogenic silicas from rice hull ash through digestion in 5% aqueous alkaline solutions of sodium hydroxide (NaOH) or potassium hydroxide (KOH).

Similarly produced biogenic silicas have also been used in materials applications. International Patent Application No. WO 01/85638 describes fine-celled foam compositions based on biogenic silicas derived from rice hull ashes with applications in, for example building panels, where the foam serves to provide thermal and fire resistance.

Although the use of alkali metal silicates to produce plant fibre or particle boards for the construction industry is known, there are no reports of the use of bio derived silicas for this purpose. The use of such bio derived silicas can help, inter alia, to create a greener product and has other advantages described herein.

Production of bio-silicate solutions from biogenic silicas from plant derived sources is known and already commercially utilised. However in all cases the silicas are dissolved in strongly alkaline solutions typically NaOH or KOH. We have found we are able to dissolve silicas without the need for auxiliary NaOH or KOH.

### SUMMARY OF THE INVENTION

Production of bio-silicate solutions from biogenic silicas from plant derived sources is known and already commercially utilised. However in all cases the silicas are dissolved in strongly alkaline solutions typically NaOH or KOH. We have now found that silicas may be dissolved without the need for auxiliary NaOH or KOH.

Plant materials naturally contain sodium and/or potassium and as a result, upon combustion such materials generate highly basic oxides, such as Na₂O and K₂O. In typical known processes the ashes from biomass combustion are cooled and allowed to react with CO₂ to produce the carbonate, which reduces the alkalinity of the ash. In our process the ashes are quenched in water straight after burning minimising the opportunity for reaction with CO₂. This means that we can employ the natural alkalinity of these metals to dissolve silicas. Moreover, many plants contain silica and alkali metals, M, (Na/K) in ratios which are preferred for production of useful silicate solutions. Thus, by careful selection of raw materials/blends we can achieve desired ratios of MO₂:SiO₂ for our binding applications.

According to first aspect of the invention we provide a structural material comprising a substrate and a binder characterised in that the binder comprises an alkali metal bio-silicate.

In a preferred aspect of the invention, the alkali metal bio-silicate may be derived from one or more alkali metal oxides (M₂O), typically Sodium or Potassium oxides or an aqueous solution thereof. In addition, if necessary, small amounts of NaOH or KOH can be added but this still represents an important reduction in the amount of auxiliary alkaline solutions used.

Thus, the bio-silicate is or is derived from one or more alkali metal silicates or an aqueous solution of one or more alkali metal silicates.

Although the present invention may provide a variety of structural materials, it is a particular aspect of the present invention to provide a structural material in the form of a structural particulate material, fibre board or panel, e.g. incorporating a biomass- or plant-based filler for applications in construction and/or the furniture industry. Thus, for example, the structural particulate material, fibre board or panel of the invention may suitably be a replacement for MDF (medium density fibreboard) or chipboard.

The ratio of SiO₂:M₂O may vary, but desirably for the structural particulate materials, fibre boards or panels of the present invention, the ratio is 2 or more. A high ratio is desirable for adhesive materials, such as fibre boards. Thus, the ratio may be from 2 to 9, or 2 to 6, or 2 to 5, or 2 to 4, depending upon, inter alia, the nature of material that is produced.

In this aspect of the invention the substrate is desirably a biomass substrate. The biomass may, for example, be a residue from activities such as agricultural food production.

Furthermore the binder may comprise a proportion of a bio-silicate and, in addition, an inorganic mineral silicate binder. The bio-silicate is derived from a plant source and may be in aqueous or anhydrous form.

A hardener may also be included which may desirably be derived from a plant source. The hardener may be present in situ in the biomass. Thus, the hardener may be a plant oil or wax.

A hardener is a biomass derived organic compound or a mixture of compounds or an output stream pure/un-pure from bio-processing of biomass, such as fermentation or biodiesel production, which contain organic compounds capable of polymerising alkali metal silicates (and in particular Na and/or K silicates) and initiating curing by consuming the alkali in the solution and thus lowering the pH to sufficient levels. Such hardeners can include bio-derived acids or compounds capable of being hydrolysed to acids such as esters, amines.

It should be noted that the silicate solution can be cured by evaporating the water—the dried material remains highly soluble unless heated to high temperatures—use of hardener generally makes it less susceptible to water

In a preferred aspect of the present invention the structural material may be substantially free of additional (chemical) base.

Use of organic compounds such as acid or esters are known, but the use of these compounds from plant sources and, in particular, the use of crude product streams from bio-processing of biomass (for example, fermentation or biodiesel generation) help to provide a green plant derived product and help in the utilisation of product streams without additional separations and processing steps which is important in terms of energy and resource conservation. Additionally, the use of in situ hardeners derived from the surface chemistries of the plant filler/substrate is novel. Adequate hardening functionalities capable of reacting with/consuming the base in alkali metal silicate solutions (and thus lowering the pH and causing precipitation) can be generated through simple pre-treatment processing such as acid washing or thermal treatment. The fact that the hardener may cover the surface of the substrate may help to produce better materials by minimising penetration of silicate solutions into particles, since silicate will harden upon contact with the surface. This means that less silicate is needed for binding and the interaction between the silicate and surface hardener produces a better key between the particles and the binder, thus yielding stronger structural materials as hereinbefore described.

According to a further aspect of the invention we provide a process for the manufacture of a structural material comprising a substrate and a bio-silicate binder as hereinbefore described which comprises the steps of:
combustion of a biomass material to produce an ash;
synthesis of a bio-silicate binder from the ash;
mixing the bio-silicate with an optionally pre-treated substrate material;
forming the structural material into a desired shape; and
curing the material.

In particular, the process of the invention comprises quenching the ash in an aqueous medium. In particular, the process comprises quenching the ash before it substantially reacts with CO₂, thus maintaining the high alkalinity of the ash.

In the process of the present invention the ash should be quenched straight away to produce a novel bio silicate material. The final step typically involves heating to drive off water and pressing to maintain panel structure and develop good packing in the internal structure of the material. Furthermore, the pre-treatment can represent two types of processes—one which improves surface characteristics of the plant material to enable better wetting with the aqueous binder or to help cohesion between particles/fibres. In another pre-treatment method the surface of the substrate can be converted to contain chemical functionalities capable of acting as hardener, thus giving the substrate in-situ hardener capability.

Although it is desirable that the process of the present invention utilises a biomass derived substrate material, it will be understood by the person skilled in the art that the bio-silicates hereinbefore described may be used in conjunction with synthetic material, e.g. non-biomass derived materials and mixtures of synthetic and biomass derived materials.

The agricultural material used as the biomass substrate of the present invention may, for example, be applied as dry biomass particles/fibres and mixed with an aqueous solution of one or more alkali metal silicates.

The bio-silicates used in the present invention use less or no auxiliary NaOH than conventional silicates and can also be spray-dried in a conventional manner to produce an anhydrous powder.

The process of the invention may include the addition of a hardener and/or pre-treatment of the substrate, such as, one or more of mechanical processing, extraction of oils and/or waxes and chemical or physico-chemical treatment.

### 1. Preparation Process:

We disclose a methodology for the preparation of structured materials in which plant-based raw materials are used to generate all main components of the product through a holistic utilisation approach also known as a biorefinery concept. Analogous to the petroleum refinery, in a biorefinery, biomass is used for direct or indirect energy generation (combustion and biofuels), synthesis of basic and complex chemicals and materials. The main constituent components which can be derived from plant biomass resources include the aggregate (substrate), binder, binder setting agent and some or all of the modifiers. Representative applications include, but are not limited to: flat boards and shaped materials such as tubes or other moulded products. Such representative applications could include, for example, building and construction materials or components, packaging, materials for the furniture industry and other areas where composite materials are applicable. This approach aims for complete utilisation of the raw material through not only the utilisation of its raw structural form in the substrate but also by utilising the minor components and/or chemical functionalities of plant biomass material and also waste streams or co-products of the major applications where biomass and particularly waste biomass is utilised: power and fuel generation. By integrating the production of its constituents and the utilisation of waste/low value co-product streams the process minimises its environmental footprint, reduces overall costs and enhances its environmental credentials. The concept of the integrated process in the representative type applications is illustrated in scheme 1 herein. The process can be used to produce whole products or parts or components of products.

Furthermore, we wish to disclose novel elements to the overall process. The process elements can be integrated as in scheme 1 or can be used individually to enhance other processes.

### 2. Binder:

The binder used in the system may be a metal silicate binder which, unlike traditional binders, of this type is derived from plant sources. The new binder can be used in an aqueous or an anhydrous form in the same manner and with equivalent performance as the- conventional binders, but differing from the conventional materials in the source of the raw materials and the environmental footprint of the preparation process. While the traditional process fuses sand and a metal base the plant derived silicate referred to as a bio-silicate source at least in part its necessary metal cations and silicate anions from inorganic compounds naturally occurring in plants. In many plants the content of silicate and metal ions is considerable and the use of this resource within the biorefinery concept ensures maximised utilisation of the raw plant materials, it minimises waste and simplifies processing. Additionally, this eliminates or minimises the need for an additional base for the preparation of the binder. Based on the performance and structural characteristics, in addition to the representative applications described in this disclosure, such new binder should be equally suitable for any current or future applications where the traditional silicate binder is utilised.

### 3. Hardener:

The hardener in this invention can be derived from biomass sources and can be used as a separate component which is added to the system or it can be present in situ in the substrate. Chemical functionalities naturally forming part of the chemical structure of the substrate can serve as hardeners without modification or be chemically or physically derivatised to hardeners. Plant compounds, such as oils, waxes or others naturally-present together with the substrate can be extracted from plants and either be used directly as hardeners or be physically/chemically converted to hardeners. In addition to the representative applications, such hardeners especially in their separate form can be utilised in other areas suitable for the binder described in point 2 above.

### 4. Substrate:

Pre-treatment of the substrate can improve its applicability in example applications. Oils and waxes naturally present in the plant substrates can inhibit good cohesion between substrate particles leading to poor mechanical properties. In this invention the inherent plant oils or the surface waxes can be used directly as hardeners or be converted to hardeners through chemical or physical modification as described in the previous paragraph. Alternatively the plant oils/waxes present on the materials surface can be extracted to enhance wetting and cohesion characteristics while providing a raw material for the hardener production or other potential high value products for applications in pharmaceuticals, cosmetics, food additives, preservatives and others.

### DESCRIPTION OF THE PREFERRED EMBODIMENTS

In a typical process the primary raw materials are plant residues from agricultural, forestry or related activities or primarily cellulosic or lignocellulosic residues resulting from processing plant materials for other applications, for example, the residual seed meal from seed oil pressing for food and/or biodiesel production. To ensure the lowest environmental footprint is attained residues rather than specific products are preferred but this preference is not essential.

### Substrate

The primary raw material constitutes the main substrate (aggregate). Other materials such as inorganic fillers may be added to afford specific mechanical, physical or chemical characteristics if these cannot be easily achieved with the plant material. These other materials will be termed co-aggregates. It should be noted that inorganic elements also form part of the plant-based substrate. In some cases the natural inorganic component in the substrate can be substantial and this component will remain as the primary aggregate rather than the additionally added co-aggregate. Furthermore the natural inorganic component of the primary raw materials will also serve as the raw material for production of the binder through dissolution as described below. The undissolved inorganic material (typically comprising plant salts and silicates) can be separated from the binder or allowed to remain in the binder solution as solids, or reintroduced into the product formulation during production of the end products thus minimising any waste in the overall process. As such it will be classified as a co-aggregate in addition to the external (non-plant derived) inorganic aggregates. In addition to their co-aggregate function the plant derived inorganic components, due the inherent variety of salts present (such as magnesium or calcium based salts), can also act as additives modifying the bulk properties of the binder system or the whole product. The use or the amount of co-aggregate incorporated will be based on the requirements of the end application and they are not the primary focus of this disclosure.

### Substrate Pre-Treatment

The substrate can be used as is or can be processed/pre-treated to enhance its compatibility with other product formulation components and increase its functionality in the product formulation. The pre-treatment constitutes the following main processes which can be used independently or in conjunction:
a) Mechanical/physical processing such as chopping, grinding, milling and pelletising which can be used to control the particle size/shape of the substrate which control packing, contact area and other properties in the product formulation. In conjunction with the mechanical and physical characteristics of the particle these will control the overall (and in particular the mechanical) properties of the end product. This type of pre-treatment will typically be the initial stage of substrate processing and it is not the main focus of this invention.
b) Extraction of plant components such as oils or waxes, which can help to increase hydrophylicity of the surface. Such pre-treatment can enhance surface wetting by the aqueous binder solution or surface interaction between components (through polar interactions) thus increasing adhesion and ultimately the binding of components and mechanical strength of the product. The extracts themselves have inherent value. Plant oils and waxes can be utilised in many applications in the pharmaceutical, cosmetic, food, agricultural, fuel and power generation. They can also be used in the production of the hardener for the representative application as described below. In fact it is likely that the extracts will more commercially valuable than the residual, pre-treated substrate. The type of extraction technology used can vary but extraction with green (environmentally benign) solvents, such as supercritical CO₂ is preferred for this pre-treatment.
c) Chemical or physico-chemical treatment such as chemical derivatisation or thermo-chemical processing can be applied to untreated substrate or substrate which has undergone treatments described in point a) and b). Such treatment can modify chemical functionality of the main structural components of the substrate (cellulose, hemicellulose and lignin), plant metabolites such as oils or waxes present in or on the substrate or other minor components. Such derivatisation of chemical functionalities can help to increase compatibility with other formulation components and improve mechanical characteristics in the same way as described in point b). Furthermore it can help to attain the specific chemical functionalities necessary for the hardener component of the system thus creating a substrate with an in situ hardener as described below. In a preferred embodiment the thermochemical treatment can involve simply heating in air or water (note that either the binder or the hardener or both can be in a aqueous solution) or treatment with chemical reagents preferably products, co-products or residues of associated processing industries such as biodiesel production and carbohydrate fermentation. Such reagents should preferably not require purification and should preferably be of low value but should contain or be capable of forming to derive the preferred chemical functionalities for surface enhancement and preferably be capable of in situ hardener formation. An example of such reagents could be cellulose/starch fermentation broth mixtures or low quality biodiesel products.

The type of pre-treatment used as well as specific procedures and conditions will vary between substrates. In some cases certain pre-treatment procedures might not yield any/significant improvement and in other cases certain treatment, e.g. extraction might to some extent negate subsequent treatments. Although pre-treatment is not a necessary procedure it is preferable to apply at least 1 method and if appropriate 2 or 3 methods.

### Binder

The binder is largely an earth metal (Na or K) silicate aqueous solution or anhydrous powder derived from the solution. The binder should preferably be derived from residual materials, which are rich in silicate. This could for example include waste glass or perlite which at least partly can be dissolved with aqueous soda/potash solution. However, most preferably the silicate solution will be derived from inorganic compounds contained in plant material and in particular the plant silicate.

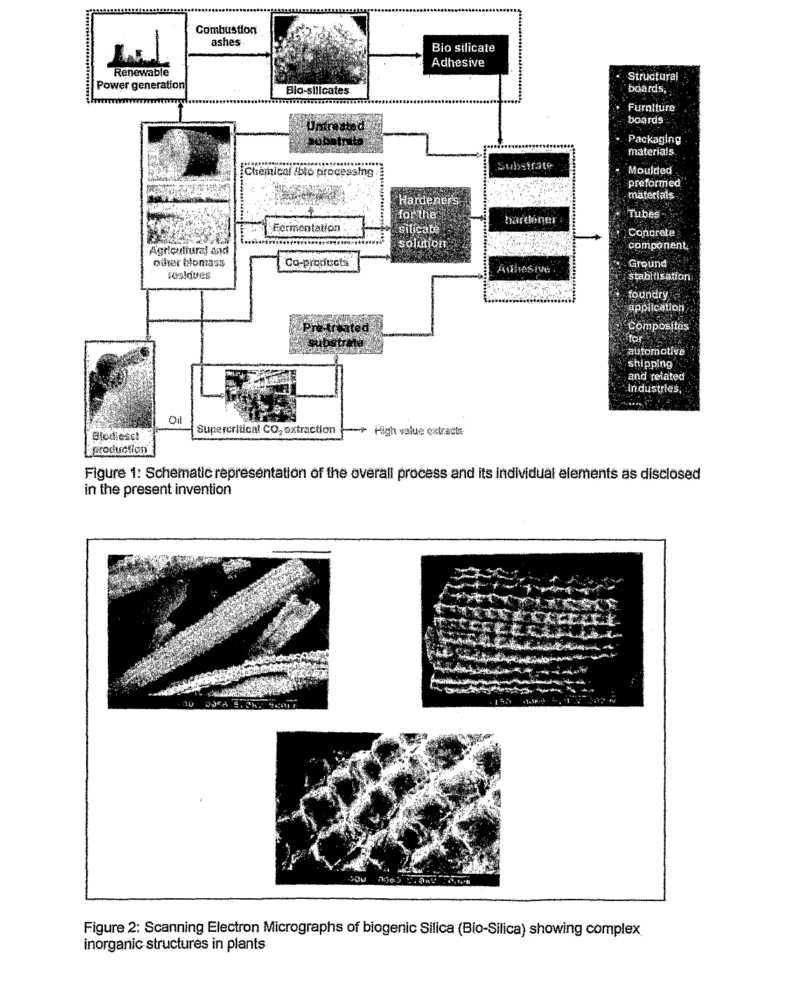

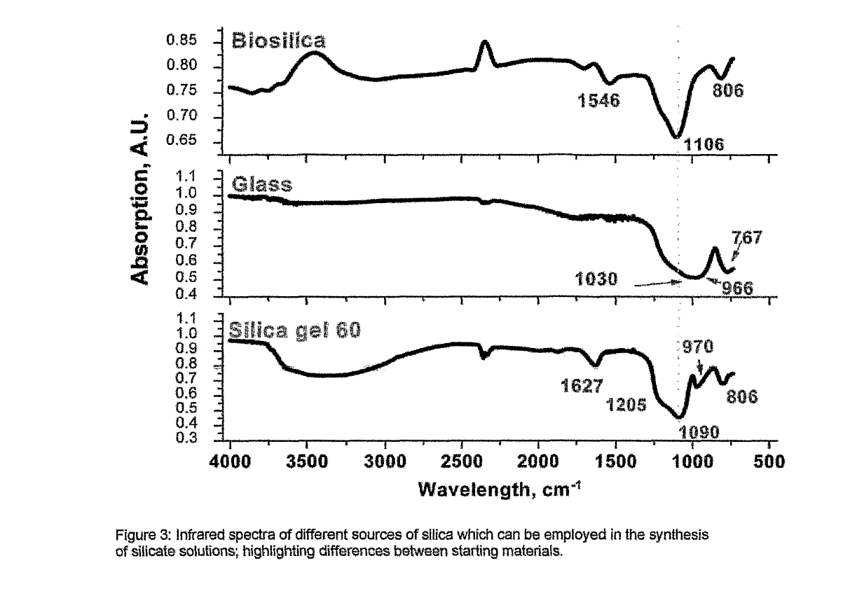

Most plants contain silica. It is an important structural component of many plants as illustrated in FIG. 2 showing structural silica from rice husks. Silica found in plants (bio-silica) is structurally quite different from silica from sand or even processed silica in glasses as illustrated by the infrared spectra of the three sources in FIG. 3. This is important in terms of differences in starting materials used traditionally and those presented in this disclosure. It should be noted though that the structure, and thus the infrared spectrum, of bio-silica will change depending on chemical or physico-chemical treatments it is exposed to.

The amounts of silica in plants vary between and even within species based on growth conditions, and it is preferable for this invention to utilise species with high inherent silicate content. In the first stage the organic plant components are separated from the inorganic components. This can be achieved through biological or chemical digestion of the organic component, but typically in this embodiment the organic plant material is burned for its calorific value for energy generation. The waste/low value residue of the combustion process will contain the inorganic components including silicate and typically some uncombusted carbonized organic material the amount of which varies depending on the type of material and combustion conditions. The residual ashes will then be treated with sodium/potassium hydroxide solution or fused at high temperature with the metal carbonates or hydroxides and dissolved in water preferably hot water in excess of 60° C. and most preferably in excess of 100° C. to form the silicate solution. Undissolved silica and other inorganic components will form part of the co-aggregate, which could be separated from the solution through filtration or other standard means.

Another preferred embodiment of this disclosure aims to use the sodium and/or potassium naturally present in plants (and thus the combusted ashes) to form the silicate solution without or with minimal usage of added metal hydroxide. Many plant species contain silicate and sodium and/or potassium in ratios” which are known to be preferred in traditional applications of silicate binders. Typically ashes directly from the combustion process will be treated with water to form a caustic solution from the metal oxides, which will aid the dissolution of the silica in the ashes. If necessary the temperature can be raised and/or metal hydroxide can be added to the solution to aid the dissolution process and if required either metal hydroxide or silica can be added to adjust the metal to silicate ratio in the solution to increase its effectiveness in desired applications.

Metal silicate solution prepared from plant-sourced silicate with or without the addition of external metal hydroxide are termed bio-silicate solutions in this disclosure while the silica present in plants is termed bio-silica. Once the bio-silicate solution has been formed it will perform in the same way as the traditional silicate solution if at the same temperature, atomic metal to silicon ratio, and the same concentration in the aqueous solution. Its performance in the representative applications will be equivalent to the traditional binder under equivalent conditions. Outside the representative applications the bio-silicate solutions will also be suitable for the applications, in which the traditional binder is currently employed. The bio-silicate binder can be used in a mixture with the traditional binder for example to augment its overall environmental performance. A percentage of bio-silicate can be used in the representative applications but it is preferable in this disclosure that the percentage represents an excess in comparison to the traditional silicate and more preferable if the bio-silicate is used as the sole binder.

### Hardener

The role of the hardener is to consume/react with the metal hydroxide in the binder and thus lower the pH of the aqueous solution. This in turn causes the initiation of silicate binder polymerisation. This is known as chemical setting and the silicate polymer precipitates out of the silicate solution. The silicate solution can also be solidified through evaporation of water in the solution. Both chemically set and evaporated silicate can be hardened at elevated temperatures in excess of 150° C. by condensation of structural hydroxyl groups and removal of water from the chemical structure of the binder. This section of the preferred embodiments will deal only with chemical setting agents.

Many chemical compounds and chemical functionalities will be cable of producing the effect required of a hardener. It is not the purpose of this disclosure to identify new chemical functionalities capable of exerting such effects, but rather a new process of introducing hardeners into the system as well as a new way in which the hardeners can be derived within the biorefinery concept employed in this system.

In the present disclosure compounds, compound mixtures and even individual functionalities capable of exerting a chemical hardening effect on the silicate/bio-silicate solution are termed hardening agents in the present invention and are preferably although not necessarily or not wholly derived from plant resources. It is preferable that the agents are derived by chemical, thermo-chemical, microwave or ultrasonic processing of plant biomass materials or more preferably by enzymatic/microbial fermentation.

The hardener can be prepared and processed externally from raw plant biomass or from extracted plant compounds and then added to the end-product formulation. Alternatively the processing can be performed on the substrate as described in the substrate pre-treatment section above.

In a typical process for an external hardening agent preferably products/co-products from biomass fermentation or biodiesel production are used either as relatively pure products (acids or esters) or preferably as product mixtures or impure product families such as impure mixture of esters or organic acids as these minimise processing steps and lower costs. Unfermented residues in the broth can act as co-aggregates in the product formulation. For internal/in situ hardeners preferably fermentation broths or biodiesel or other biofuel components are used to modify the surface or more preferably the surface is activated to act as an agent through thermochemical, or microwave treatment such as heating in air or water at elevated temperatures preferably above 800 C or more preferably above 1000 C as described in the substrate treatment section.

### Overall Process

In a typical process the majority of the primary biomass raw materials are burned for energy generation and the ashes are used for synthesis of a bio-silicate binder solution in a preferable manner described above. A portion of biomass is used for fermentation or biodiesel or other fuel production and the fermentation broth and crude biodiesel or biofuel products, co-products or mixture is used as hardener and more preferably the hardener is derived in situ in the substrate. Finally the substrate is taken from the primary biomass and preferably mechanically pulverised to a smaller and more uniform particle size. The oils and waxes, if substantive in the substrate are preferably extracted and utilised in external application or in hardener generation as in above. Then in a preferable addition order the substrate is mixed with the hardener in aqueous solution. Alternatively the oils and waxes and/or preferably the structural components of the substrate are derivitised to act as agents in situ in the hardener. The silicate solution and preferably a mixture of silicate and bio-silicate solution or more preferably the bio-silicate solution are then added and the product formulation is then pressed into a desired shaped whilst heated till dry and then preferably heated till or above 150° C. to initiate secondary hardening process.

If aqueous hardener solution is employed the hardener is preferably added as an anhydrous powder derived from the silicate/bio-silicate solution in order to minimise the overall water content of the product formulation. Additives such as starch or chitosan, light weight fillers or others can be added to the product formulation to affect to final product properties such as flexibility or weight to suit specific applications.

In representative applications the amount of binder used is between 5 and 80% by of the substrate and preferably 10 to 60% and more preferably 20 to 40%. The amount of hardener used will vary depending on the type of hardener and the molar concentration of the hardener agents in the solution being applied. The molar concentration of the agents should be between 1 and 80% of the molar amount of sodium or potassium metal in the binder solution and it should be sufficient to set hardener without heat initiated hardening.

According to a further aspect of the invention we also provide the use of an alkali metal bio-silicate as a binder in a structural material.

Materials, e.g. bio-silicate materials, may be produced using a lower SiO₂:M₂O ratio. Thus, it may be desirable to produce materials using a SiO₂:M₂O ratio of 2 or less, e.g. from 0.5 to 2, desirably less than 2, e.g. 0.5 to less than 2, or 0.5 to 1.5 or 0.75 to 1.25. Materials produced according to this aspect of the invention may comprise, for example, non-adhesive structural materials. However, materials produced according to this aspect of the invention may have utility as non-structural materials. One example of such a non-structural material is a cleaning material.

Thus, according to this aspect of the invention we provide a material comprising an alkali metal bio-silicate which comprises a SiO₂:M₂O ratio of 2 or less.

The invention will now be illustrated by way of example only and with reference to the accompanying drawings.

### EXAMPLES

### 1. Preparation of Bio-Silicate from Partly Combusted Rice Husk Ashes at Low Temperature

A residue, ash, from partial combustion of rice husk was used in the preparation. The residue contained 62% biogenic silica, 35% carbon around 2% of metals and around 0.5% of crystalline silica by weight. The ash was combined in a polypropylene container with NaOH in molar ratio of Na20 to Si0₂ of 3.2 based on the silica content of the ash and water was added to give a total of 40% by wt of solids. The mixture was stirred at room temperature for 24 hrs to allow dissolution and equilibration. The mixture was filtered and the resulting solution was analysed by IPC indicating 2156 ppm of silica, 6713 pm of sodium, 266 ppm of potassium.

### 2. Preparation of Bio-Silicate from Partly Combusted Rice Husks Ashes at High Temperature

A residue, ash, from partial combustion of rice husks as in example 1 was used in the preparation. 1.1309 g of 62% silica content rice hull ash was mixed with 0.5934 g anhydrous NaOH and 3.276 g distilled water. This solution was then heated in a sealed glass vial in the microwave under the following conditions: Power—100 W, Ramp time—1 min, Hold time—4 min, Max T—150′C, Max pressure—250 psi. The pressure initially reached around 175 psi and then dropped to 50 psi during the reaction. The resulting mixture was filtered and diluted with distilled water for ICP analysis indicating 2641 ppm of silica, 3198 pm of sodium, 144 ppm of potassium.

### 3. Preparation of Bio-Silicate from Rice Husk Ashes at Low Temperature

Following the same procedure as in example 1 ash from rice husks, which nearly completely combusted were used for production of silicate solution. The silica content in the ash was over 90% and amount of NaOH was adjusted to maintain the molar ratio of Na20 to Si0₂ at 3.2. The resulting solution was analysed by IPC indicating 2140 ppm of silica, 8707 pm of sodium, 278 ppm of potassium.

### 4. Preparation of Bio-Silicate from Rice Husks Ashes at High Temperature

A residue, ash, from rice husks combustion as in example 1 was used in the preparation. 0.7797 g of 90% silica content rice hull ash was mixed with 0.5934 g anhydrous NaOH and 3.627 g distilled water. This solution was then heated in a sealed glass vial in a microwave using exactly the same conditions as for example 2. The resulting mixture was filtered and diluted with distilled water for ICP analysis indicating 6999 ppm of silica, 7728 pm of sodium, 337 ppm of potassium.

### 5. Preparation of Bio-Silicate from Waste Glass at Low Temperature

Following the same procedure as in example 1 waste glass, was used for production of silicate solution. The glass was finely milled to a particle size of 125 micrometers. The silica content in the glass was near 100% and amount of NaOH was adjusted to maintain the molar ratio of Na₂0 to Si0₂ at 3.2. The resulting solution was filtered from milled glass powder and analysed by IPC indicating 1598 ppm of silica, 9349 pm of sodium, 42 ppm of potassium.

### 6. Preparation of Bio-Silicate Solution by High Temperature Fusing

Rice husks ashes as those described in example 1 were employed. A base, NaOH/or Na2C03 was mixed with the ash and the mixture was heated in a flame at over 10aO° C. for about 30 min or until visible melting. The resulting solids were dissolved in hot water at approximately 60° C. and filtered to remove any residual insolubles and the solution was tested for setting in separate experiments. Results are summarised in the table below.

| Ash (62% | | | | |
|---|---|---|---|---|
| silica) | Sodium | | | |
| Wt/g | source | Wt/g | Heating Method | Solution |
| 3.95 | NaOH | 0.83 | Flame fused at over | Soluble in hot |
| | | | 1000° C. for 30 min. | water c60° C. |
| 3.97 | Na₂CO₃ | 1.01 | Flame fused at over | Soluble in hot |
| | | | 1000° C. for 30 min. | water c60° C. |

### 7. Commercially Available Products

### Variation in Hardener Amount on Setting Specification of Sodium Silicate Solution

Commercial silicate solution (Ineos Crystal 70) was mixed in varying amounts with a commercial hardener to examine the setting behaviour and provide comparison for bio-derived hardeners and solutions. Results are summarised below.

| Vol % of | | | |
|---|---|---|---|
| hardener | Reaction Observation | Setting | Final Product |
| 100% | Two separate layers hard | Very Slow | Poorly set around the sides of the |
| | to mix | (days) | tube - two layers still remain |
| 80% | Two separate layers hard | Very Slow | Mostly set at the interface of the |
| | to mix | | two layers |
| 60% | Two separate layers hard | Very Slow | Mostly set at the interface of the |
| | to mix | | two layers |
| 40% | Two separate layers hard | Slow | Distinctive regions in the final |
| | to mix | | product poor strength |
| 20% | Emulsion formed | Quick | Solid throughout a small amount |
| | | | of hardener still liquid on top |
| 10% | Emulsion formed | Very Quick | Solid throughout a small amount |
| | | | of hardener still liquid on top |

### 8. Use of Green Plant Carbohydrate Type Hardeners

### Starch

Commercial silicate solutions were mixed with solid starch and starch aqueous suspensions (Starch Solution) to examine the performance of starch as hardener. The binding strength was also tested for two samples using a peel test in which two 2 cm×2 cm cardboard pieces were stuck together with the resulting formulation, left overnight then peeled apart. Experimental conditions and results are summarised in the table below.

| | | | Quantity | | | |
|---|---|---|---|---|---|---|
| Silicate | Quantity | Hardener | Vol % | 1-10 mins | 12 hours | Binding test |
| PQ | 1.8 ml | 4% starch | 10% | Precipitate | Precipitate | Bound |
| corporation | | solution | | | | |
| INEOS | 1.8 ml | 4% starch | 10% | Precipitate | Precipitate | Bound |
| (crystal 70) | | solution | | | | |
| INEOS | 1.8 ml | Starch | 200 mg | Viscous | Viscous | Not |
| (crystal 70) | | solid | | emulsion | emulsion | tested |

### 9. Use of Products and Raw Materials of Biodiesel Production as Hardeners

Commercial silicate solutions were mixed with glycerol and standard household vegetable oil to represent products and raw materials of biodiesel production processes. The presence of impurities was also simulated by addition of a small amount of standard household surfactant solution. Their performance as hardener for commercial silicates was examined. The binding strength of glycerol initiated samples was also tested using the same peel test as described in Example 8. Experimental conditions and results are summarised in the table below.

| | Quanti | | Quanti | | | |
|---|---|---|---|---|---|---|
| Silicate solution | ml | Hardener | ml | 1-10 mins | 12 hours | Binding |
| PQ corporation | 1.8 | Glycerol | 0.18 | Liquid | Liquid | Bound |
| INEOS | 1.8 | Glycerol | 0.18 | Liquid | Liquid | Bound |
| INEOS (crystal | 1.8 | Vegetable oil | 1.8 | Emulsion | 2 phases | Not |
| 70) | | (glycerol triester) | | | | tested |
| INEOS (crystal | 1.8 | Vegetable oil + | 1.8+ | Emulsion | Emulsion | Not |
| 70) | | Surfactant (1 drop) | | | | tested |

### 10. Use of Bio-Fermentation Type Acids as Hardeners

Commercial silica solutions were mixed with organic acids typical of products found in carbohydrate bio-fermentation processes to test the performance of such acids as hardener for the silicates. The binding strength was tested for two succinic acid samples using the same peel test as described in Example 8. Experimental conditions and results are summarised in the table below.

| Silicate | | | | | | | Binding |
|---|---|---|---|---|---|---|---|
| Solution | Quantity | Hardener | Quantity | | 1-10 mins | 12 hours | test |
| PQ PQ | 1.8 ml | 5% succinic | 0.18 | ml | Liquid | Liquid | Bound |
| corporation | | acid solution | | | | | |
| INEOS | 1.8 ml | 5% succinic | 0.18 | ml | Liquid | Liquid | Bound |
| (crystal 70) | | acid solution | | | | | |
| INEOS | 5.4 ml | 5% succinic | 1.62 | ml | Precipitates | redissolves | Not |
| (crystal 70) | | acid solution | | | | | tested |
| INEOS | 1.8 ml | 5% succinic | 1.8 | ml | Sets | Set | Not |
| (crystal 70) | | acid solution | | | instantly | | tested |
| INEOS | 1.8 ml | succinic acid | 200 | mg | Sets rapidly | Set | Not |
| (crystal 70) | | solution | | | | | tested |
| INEOS | 1.8 ml | 10% oxalic | 1 | ml | Sets rapidly | Set | Not |
| (crystal 70) | | acid solution | | | | | tested |

### 11. Use of Bio Esters as Hardeners for Commercial and Bio-Silicates

Commercial silicate solutions and plant-derived silicate solutions (Example 6) were mixed with ethyl lactate representing typical esterified bio-fermentation acids. The performance of ester as a hardener for the silicate solutions was examined. Experimental conditions and results are summarised in the table below.

| | | | | 1-10 | |
|---|---|---|---|---|---|
| Silicate solution | Quantity | Hardener | Quantity | mins | 12 |
| INEOS (crystal 70) | 1.8 ml | Ethyl Lactate | 1.8 ml | Sets | Set |
| INEOS (crystal 70) | 1.8 ml | Ethyl Lactate | 1.8 ml | Sets | Set |
| BioSilica-NaOH | 1.8 ml | Ethyl Lactate | 1.8 ml | Sets | Set |
| fused | | | | rapidly | |
| BioSilica-Na₂CO₃ | 1.8 ml | Ethyl Lactate | 1.8 ml | Sets | Set |
| fused | | | | rapidly | |

### 11. Use of Standard Biodiesel and Crude Feedstock and Co-Product Streams as Hardeners

Commercially produced standard purity biodiesel as well as low value crude raw materials and co-product streams from a commercial biodiesel producer have been tested for their applicability as hardeners for a commercial silicate (Ineos Crystal 70). Experimental conditions and observations are included in the table below. Biodiesel feedstocks include crude biodiesel, vegetable oil, surfactants and other impurities. The standard biodiesel product is fatty acid ester of at least 93% purity. G-phase is the separated processed/unprocessed glycerol phase. These demonstrate that low value waste for biodiesel production industry can be employed as effective setting agents for silicates, to replace the current more expensive silicate hardeners.

| | Volume | Volume | |
|---|---|---|---|
| | Silicate | hardener | Evidence of |
| Description of hardener | (ml) | (ml) | polymerisation |
| Impure Biodiesel feedstock1 | 1.6 | 0.4 | Yes |
| impure Biodiesel feedstock2 | 1.2 | 0.8 | Yes |
| impure Biodiesel feedstock3 | 1.2 | 0.8 | Yes |
| standard purity biodiesel product | 1.2 | 0.8 | Yes |
| Added G-phase from biodiesel. | 1.6 | 0.4 | Yes |
| Stirred with G-phase from | 1.4 | 0.6 | Yes |
| biodiesel | | | |
| Stirred with G-phase from | 1.2 | 0.8 | Yes |
| biodiesel, | | | |

### 13. Use of Crude Carbohydrate Bio-Fermentation Broths Hardeners

Low value large scale crude fermentation broths have been tested for their applicability as hardeners for a commercial silicate (Ineos Crystal 70). A range of batches of fermentation broths were tested. The broths come from microbial fermentation of wholesale wheat grain waste using Actinobacillus succinogenes in aqueous medium. The resulting broth contained a mixture of carbohydrate derived acids, including succinic, lactic, pyruvic, acetic acids with succinct acid being the predominant component. The total organic acid content was around 6%. Experimental conditions and observations are included in the table below.

| Description of | Volume Silicate | Volume hardener | Evidence of |
|---|---|---|---|
| Hardener | (ml) | (ml) | Polymerisation |
| Broth 70 | 1.2 | 0.8 | Yes |
| Broth 71 | 1.2 | 0.8 | Yes |

### 14. Use of Esterified Bio-Fermentation Broths as Hardeners

Fermentation broths employed in example 12 have been esterified without purification and the crude mixed esters have been tested for their applicability as hardeners for a commercial silicate solution (Ineos Crystal 70). Esters were derived by ethanol and methanol esterification employing STARBON® acids as catalysts in the broth aqueous medium. A range of batches were tested. Experimental conditions and observations are included in the table below.

| Description of | Volume | Volume hardener | Evidence of |
|---|---|---|---|
| Hardener | Silicate (ml) | (ml) | Polymerisation |
| Broth 66, esterified | 4 | 1 | Yes |
| with MeOH for | | | |
| 15 hr | | | |
| Broth 66, esterified | 4 | 1 | Yes |
| with EtOH for 3 hr | | | |
| Broth 66, esterified | 4 | 1 | Yes |
| with EtOH for 15 hr | | | |
| Broth 67, esterified | 1.6 | 0.4 | Yes |
| with EtOH for 18 hr, | | | |
| pH ~6-7 | | | |
| Broth 67, esterified | 1.2 | 0.8 | Yes |
| with EtOH for 18 hr, | | | |
| pH ~6-8 | | | |
| Broth 66, esterified | 1.6 | 0.4 | Yes |
| with EtOH for 18 hr, | | | |
| pH ~9 | | | |
| Broth 66, esterified | 1.2 | 0.8 | Yes |
| with EtOH for 18 hr, | | | |
| pH ~10 | | | |

### 15. Use of In-Situ and Bio-Derived Hardeners for Binding Applications

Use of bio-hardeners with commercial silicates for binding wood flour was tested. Wood flour was boiled with water to activate its surface as an in situ hardening agent for the silicate. The silicate was added to the pre-treated wood mixture, pressed in a mould and dried to determine the cohesiveness of the wood flour. In another experiment the wood was wetted at room temperature and then successively a biodiesel derived co-product as hardener and commercial silicate (Ineos Crystal 70) were added. The mixture was pressed in a mould as above. Finally the procedure above was repeated but now the hardener was added to the wood while it was being wetted with water for 1 hr. Experimental description and results are summarised below.

| | Mass | Weight | | Handling |
|---|---|---|---|---|
| Treatment | sawdust | silicate | Bio-hardener | Properties |
| Substrate refluxed for 2 hrs | 1.00 g | 0.28 g | N/A | Solid board after |
| in 20 ml of water then | | | | drying only |
| excess water filtered off | | | | |
| followed by addition of | | | | |
| silicate and drying on a | | | | |
| pressed mould | | | | |
| Substrate wetted for 1 hr in | 1.50 g | 0.28 g | 0.05 g of unpurified | Solid board and |
| little water followed by | | | biodiesel process | becoming a firm |
| addition of silicate and | | | co-product stream | board after drying |
| drying on a pressed mould | | | | |
| Substrate wetted for 1 hr in | 1.50 g | 0.28 g | 0.05 g of unpurified | Solid board and |
| little water and hardener | | | biodiesel process | becoming a very |
| followed by addition of | | | co-product stream | firm board after |
| silicate and drying on a | | | | drying |
| pressed mould | | | | |

### 16. Utilisation of Bio-Silicate Solution in Preparation of Paper Sludge Boards

Bio-silicate solution prepared in example 1, unfiltered was mixed with a commercial hardener R1 00 supplied by commercial producers of silicate solutions. A ratio of 1 to 10 by weight was used and the silicate solution and hardener were premixed and then poured over waste newspaper sludge and thoroughly mixed. 40% by weight of unfiltered binder mix loading was used for the mixture. The resulting paste was then spread across metal plates covered with waxed paper and then pressed in a press with simultaneous heating to 150° C. for 5 min. The resulting material was a thin 3 mm board, black in colour due to the residual carbon in the binder solution.

### 17. Utilisation of Waste-Silicate Solution in Preparation of Paper Sludge Boards

Bio-silicate solution prepared in example 3, unfiltered and containing powdered glass was mixed with a commercial hardener R100 supplied by commercial producers of silicate solutions. A ratio of 1 to 10 by weight was used and the silicate solution and hardener were premixed and then poured over waste newspaper sludge and thoroughly mixed. 40% by weight of unfiltered binder mix loading was used for the mixture. The resulting paste was then spread across metal plates covered with waxed paper and then pressed in a press with simultaneous heating at 150° C. for 5 min. The resulting material was a thin 3 mm grey board.

### 18. Utilisation of Waste-Silicate Solution in Preparation of Wood Particle Boards

Mixed wood particles were pre-soaked with approximately 5% aqueous solutions of bio-fermentation type acids: Oxalic and Succinic after thorough mixing. 20% resin loading was used. Commercial sodium silicate (Ineos crystal 120 with solids content of 65%) and commercial sodium silicate powder (Ineos) were added to the pre-treated wet mixture and the resulting formulation was pressed at 200° C. for 5 min to form 12 mm thick boards as summarised below. The boards exhibited good mechanical properties in particular when anhydrous silicate powder was used.

| | | | Internal Bond/ |
|---|---|---|---|
| Substrate | Resin | Hardener | N mm−² |
| Reclaimed Wood chips | crystal 0120 | oxalic | 0.05 |
| Reclaimed Wood chips | crystal 0120 | succinic | 0.04 |
| Reclaimed Wood chips | SS Powder | succinic | 0.28 |
| Reclaimed Wood chips | SS Powder | oxalic | 0.27 |

### 19. Dissolution of Bio-Silica without Auxiliary Alkali

6 g of milled wheat straw was combusted in a furnace at 600° C. for 6 hrs. The burned ashes were then quenched in 3.4 ml of water either immediately after burning to minimise reaction with ambient CO2 or after letting the ashes to cool at ambient conditions. In the latter sample less silicate in solution was obtained due to lower basicity of the ashes

| Combustion | Time | Ash | Si conc from integral of IR |
|---|---|---|---|
| temp. ° C. | (min) | quenching | peak (ppm) |
| 600 | 360.00 | immediate | 5184 |
| 600 | 360.00 | after cooling | 633 |

### 20. Dissolution of Bio-Silica without Auxiliary Alkali

6 g of milled wheat straw was combusted in a furnace at 600° C. for 2 hrs. The burned ashes were then quenched in 3.4 ml of water immediately after burning. The quenched solutions were then further heated with microwaves in open and closed vessels or treated with ultrasound for different periods of time. The additional processing increased the amount of dissolved silica compared to untreated control sample.

| | | | Si conc from |
|---|---|---|---|
| | Temp of further | | integral of IR peak |
| Heating method | reaction (° C.) | time (min) | (ppm) |
| — | N/A | N/A | 2668 |
| Closed Vessel | 100 | 5 | 6064 |
| microwave | | | |
| Closed Vessel | 100 | 10 | 5489 |
| microwave | | | |
| Closed Vessel | 100 | 15 | 6733 |
| microwave | | | |
| Closed Vessel | 100 | 5 | 7883 |
| microwave | | | |
| Closed Vessel | 100 | 10 | 7470 |
| microwave | | | |
| Closed Vessel | 100 | 15 | 6221 |
| microwave | | | |
| Closed Vessel | 100 | 5 | 7319 |
| microwave | | | |
| Closed Vessel | 100 | 10 | 6373 |
| microwave | | | |
| Closed Vessel | 100 | 15 | 7341 |
| microwave | | | |
| Sonication | | 5 | 5634 |
| Sonication | | 10 | 5877 |

### 21. Production of Metal Silicate Solution of Different Ratio from Biomass

In a typical procedure 6 g of milled wheat straw was combusted in a furnace at 600° C. for 6 hrs. The burned ashes were then quenched in 3.4 ml of water immediately after burning. Two different batches of straw were used, each yielding different amount of silica dissolved and different silicate to metal oxide ratios

| | Subsequent | | | | |
|---|---|---|---|---|---|
| | microwave | Si | K | Na | SiO₂:M₂O |
| Batch | reaction | (mg/l) | (mg/l) | (mg/l) | ratio |
| 1 | | 7421 | 7575 | 742 | 2.73 |
| 2 | | 3504 | 1755 | 614 | 5.56 |
| 2 | 5 min, 177° C. | 7342 | 5079 | 880 | 4.02 |
| 2 | 5 min, 100° C. | 6080 | 2077 | 755 | 8.15 |

Two further experiments were conducted were the quenched solutions were further heated at 100 and 177° C. in a microwave in a closed vessel. Results are reported in the Table above.

### 22. Effect of Surface Modification of Substrate on In Situ Hardening Capability and Performance

### Hydrogen Peroxide Wash

16.0 g milled, not dried wheat straw was mixed with 200 ml 30% w/v H2O2 and was stirred at 25° C. for 3.5 hrs then filtered and washed with 4×100 ml distilled water until clear and finally dried at 40° C. in an oven to constant weight.

Hydrogen Peroxide with Methanol Wash

7.5 g milled wheat straw was mixed with 75 ml methanol and 75 ml 30% H₂O₂. The mixture was stirring at 55° C. for 2 hrs and then stirred overnight without heating, filtered and washed with 4×250 ml distilled water and finally dried for 3.5 hrs in a vacuum oven at 80° C.

### Glycidyl Methacrylate Modification

6.0 g milled wheat straw was mixed with 150 ml 5% NaOH solution and stirred at room temperature for 30 min. 8 g glycidyl methacrylate was then added dropwise and solution stirred at room temperature overnight. Mixture was filtered and washed with 4*250 ml distilled water till a neutral pH, filtered and dried in vacuum oven for 3.5 hrs at 80° C.

### Testing Procedure

4 g of wheat straw and 14.7 g potassium silicate solution were mixed thoroughly. A portion of the mixture was packed lightly into a plastic 5 ml syringe. Cocktail stick pushed through the syringe nozzle, leaving 3.5 cm sticking out. Syringe plunger was pushed down onto mixture in syringe on weighing scales so that 4.5 kg of pressure was applied. Syringe was placed in an oven at 59° C. for 1 hr 30 min. Syringe was taken out and left to cool for 5 min before testing. Syringe placed in a loose holder. A vice was attached to cocktail stick and weights were added gradually until stick pulled out of syringe.

### Results

| Modification procedure and controls | Mass held (kg) |
|---|---|
| H₂O₂ (methanol and H₂O₂) | 2.5 |
| H₂O₂ | 4.0 |
| Modified with glycidyl methacrylate | 3.0 |
| Wheat straw (undried) | 2.0 |
| Wheat straw (dried at 105′ C.) | 2.9, 2.5, 2.8 |
| Wheat straw with 4.3 g of commercial hardener R100 | >6.0 |

1. A structural material comprising a substrate and a binder characterised in that the binder comprises an alkali metal bio-silicate.

2. A structural material according to claim 1 wherein the alkali metal bio-silicate is derived from an alkali metal oxide (M₂O) or an aqueous solution thereof.

3. A structural material according to claim 1 wherein the structural material is in the form of a structural particulate material, fibre board or panel.

4. A structural material according to claim 3 wherein the structural material is a fibre or particulate board and the ratio of SiO₂:M₂O is 2 or more.

5. A structural material according to claim 1 wherein the substrate is a biomass substrate.

6. A structural material according to claim 1 wherein the alkali metal silicate binder comprises a proportion of a bio-silicate and an inorganic silicate.

7. (canceled)

8. A structural material according to claim 1 wherein the bio-silicate is derived from a plant source and includes one or more residues from agricultural and/or food production.

9. A structural material according to claim 1 wherein the bio-silicate is in aqueous form.

10. A structural material according to claim 1 wherein the bio-silicate is in anhydrous form.

11. A structural material according to claim 1 which includes a hardener.

12. A structural material according to claim 11 wherein the hardener is derived from a plant source.

13. A structural material according to claim 12 wherein the hardener is present in situ in the biomass.

14. A structural material according to claim 12 wherein the hardener is a plant oil or wax.

15. A structural material according to claim 1 which is substantially free of additional (chemical) base.

16. A process for the manufacture of a structural material comprising a substrate and a bio-silicate binder which comprises the steps of:
combustion of a biomass material to produce an ash;
synthesis of a bio-silicate binder from the ash;
mixing the bio-silicate with an optionally pre-treated substrate material;
forming the structural material into a desired shape; and
curing the material.

17. A process according to claim 16 wherein the ash is quenched in an aqueous medium.

18. A process according to claim 16 wherein the optionally pre-treated substrate material is a biomass material.

19. A process according to claim 16 which includes the addition of a hardener.

20-21. (canceled)

22. A process according to claim 20 wherein the pre-treatment comprises extraction of oils and/or waxes.

23-24. (canceled)

25. A structural particulate material, fibre board or panel comprising a biomass substrate and a binder characterised in that the binder comprises an alkali metal bio-silicate.

26. A material comprising an alkali metal bio-silicate which comprises a SiO₂:M₂O ratio of 2 or less.

27. (canceled)
